(19) United States
(12) Patent Application Publication
(10) Pub. No.: US 2023/0115569 A1
(43) Pub. Date: Apr. 13, 2023

(54) METHOD FOR PROVIDING ACCESS PRIVILEGES LINKED TO PHYSICAL OBJECTS FOR OBTAINING GOODS AND/OR SERVICES

(71) Applicant: Connect One Digital AG, Frankfurt (DE)

(72) Inventors: Carsten Kehrein, Koblenz (DE); Thomas Nieraad, Hofheim (DE)

(21) Appl. No.: 17/945,330

(22) Filed: Sep. 15, 2022

(30) Foreign Application Priority Data
Sep. 15, 2021 (EP) 21196825.0

(51) Int. Cl. H04L 9/40; H04L 9/08; G06F 21/62

(52) U.S. Cl. CPC H04L 63/102; H04L 9/0866; G06F 21/6218

(57) ABSTRACT

The invention relates to a method for providing authorizations, linked to physical objects (101, 102, 103), for retrieving goods and/or services (30), including the steps: creating a digital representation (101′, 102′, 103′) of a physical object (101, 102, 103), preferably on an IoT platform (6), the physical object (101, 102, 103) including at least one information carrier (I), the information carrier (I) including at least one identifier (UID), the physical object (101, 102, 103) being unequivocally assignable to its digital representation (101′, 102′, 103′), based on the identifier (UID), and the information carrier (I) being readable from goods and/or services (30) by use of a mobile terminal (10) and/or by means of an output device (20) in order to at least partially access the particular digital representation (101′, 102′, 103′); providing a configurable authorization profile (101a, 102a, 103a) for the digital representation (101′, 102′, 103′), the authorization profile (101a, 102a, 103a) including at least one authorization for retrieving goods and/or services (30).

### TECHNICAL FIELD

The present invention relates in general to the technical field of information technology, and in particular to a method for providing authorizations, linked to physical objects, for retrieving goods and/or services, a digital representation of a physical object, and an IoT platform for carrying out the method, devices for carrying out the method, and a computer program for executing the method.

### BACKGROUND OF THE INVENTION

The Internet of Things (IoT) is a collective term for technologies that allow physical objects and digital objects to be linked to one another, and to cooperate using information and communication technologies. One approach implemented in the prior art is to create digital representations of physical objects. In particular in the field of lean manufacturing, options that provide an Internet of Things are used to optimize material flows, for example. A further field in which the Internet of Things has been considered in the past is the area of “smart homes.” Devices, for example customary household appliances, are provided with a digital depiction on a server, via which they may be monitored or controlled, for example. As is often necessary for a functioning Internet of Things, the devices here as well must be directly or indirectly online in order to be monitored or controlled, for example. This results in increased complexity of the device and greater energy demand. In addition, it is routinely necessary to process data that could reveal the identity of persons.

The concept of the Internet of Things in the area of provision of goods and/or services to end users still has comparatively less significance. One challenge is to also depict simple or low-cost items in an Internet of Things. A further particular challenge is to protect personal data of end users while still making goods and/or services accessible to end users in a simple manner. There is a need for improvement to make the inherent potential of the Internet of Things accessible to end users, also in the field of provision of goods and/or services.

The object of the present invention is to provide a method that allows authorizations for retrieving goods and/or services by service recipients, in particular end users, in a simple manner, in which the need for data which could reveal the identity of service recipients, in particular end users, is reduced.

Moreover, the object of the present invention is to provide a digital representation of a physical object, an IoT platform, and devices that allow the method to be carried out.

Furthermore, the object of the present invention is to provide a computer program including commands that allow the method to be carried out.

### SUMMARY

The above objects are achieved in particular by the subject matter of claims 1, 13, 14, and 15. Further features and details of the present invention result from subclaims 2 through 12, the description, and the drawings.

The method according to the invention for providing authorizations, linked to physical objects, for retrieving goods and/or services is directed in particular to the retrieval of goods and/or services by a service recipient from a service provider, and includes the steps:
creating a digital representation of a physical object, preferably on an IoT platform, the physical object including at least one information carrier,
   the information carrier including at least one identifier, the physical object being unequivocally assignable to its digital representation, based on the identifier, and
   the information carrier being readable from goods and/or services by use of a mobile terminal and/or by means of an output device in order to at least partially access the particular digital representation,
providing a configurable authorization profile for the digital representation, the authorization profile including authorizations for retrieving goods and/or services.

Within the meaning of the present invention, physical objects may in particular be everyday items or also publicly accessible items. For example, a physical object within the meaning of the present invention may be a coffee cup, a T-shirt, or a book. The linked goods and/or services may be any goods and/or services. In other words, the goods and/or services may, but do not have to, be complementary to the physical objects. For example, dispensing coffee for a coffee cup would be a good or service that is complementary to the coffee cup.

Examples of goods are the following: beverages such as coffee, beer, or juice; office supplies such as ballpoint pens or notepads; personalized items such as cups, towels, or T-shirts; foods such as fruits, vegetables, or snack foods.

Examples of services are the following: bodily services such as massages, hairdressing services, or cosmetic services; consulting services such as legal or tax initial consultations; fitness classes such as dancing, martial arts, or yoga.

A service recipient is the entity that receives the good and/or service, and in particular may be an end user. A service provider is the entity that provides the goods and/or services. A service provider may be any third party. In other words, the service provider does not have to be the issuer or the manufacturer of the physical objects.

When a digital representation of a physical object is created, in simple terms this means that a data packet that is unequivocally assigned to the physical object and/or associated with same is created on a server, preferably an IoT platform. The physical object includes an information carrier, wherein an identifier, in particular a unique identifier (UID), is readably stored on the information carrier. The unique identifier may be read by a reading device, for example, which may be designed as a mobile terminal, as part of a mobile terminal, or as part of an output device of goods and/or services. In particular, the reading device may include a camera and/or a near-field communications interface and/or a short-range communications interface. The reading device is particularly preferably designed as an NFC, RFID, or Bluetooth interface.

The unique identifier may be converted into a persistent identifier (PID) by the reading device, for example. The persistent identifier may particularly advantageously include the unique identifier to allow an unequivocal assignment to a digital representation. The persistent identifier may in particular be designed as an internet link, so that the reading device and/or the mobile terminal and/or the output device of goods and/or services may access the digital representation via the internet. Alternatively or additionally, the information carrier may be read by means of an output device that includes a reading device, in order to access the digital representation in the same way.

The digital representation may be stored in particular on an IoT platform. This may be the IoT platform that provides the configurable authorization profile for the digital representation.

The authorization profile includes one or more authorizations for retrieving goods and/or services. In order to define which authorizations or which goods and/or services are to be stored, the authorization profile may be preconfigured and/or subsequently configurable.

It is preferably provided that an owner of the physical object may access at least the authorization profile of the particular digital representation, and preferably retrieve the particular goods and/or services, by use of the mobile terminal and/or by use of the output device of goods and/or services.

In addition, it may be provided that the owner of the physical object may also activate and/or deactivate authorizations as desired from the authorizations that are available in the authorization profile, wherein only activated authorizations may be used for retrieving the particular goods and/or services, and the activation and/or deactivation of the authorizations preferably take(s) place by use of a mobile terminal that is configurable for this purpose.

Furthermore, it may be provided that the at least one authorization present in the authorization profile is activatable and/or deactivatable by an owner of the physical object by use of a mobile terminal, the activation and/or deactivation of the at least one authorization taking place in the digital representation. All authorizations within the digital representation are thus stored on the IoT platform. To access these authorizations, only object-related data, for example the identifier of the information carrier of a particular physical object, are necessary, which allows an unequivocal assignment to a digital representation. Data that could reveal the identity of certain persons are thus not necessary.

Due to the option for activating or deactivating available authorizations, a quasi-two-stage selection of authorizations is provided in a simple manner. In the first stage, the authorization profile is prepared using available authorizations. This may be carried out, for example, by a provider of the IoT platform or by an issuer of the particular physical object or by an authorization issuer, who may be a third party. In the second stage the owner, who at the same time may be the service recipient, in particular the end user, is provided with the option to individually select, according to his/her own preferences, those authorizations that he/she would like to activate and/or deactivate. The service recipient is thus advantageously given the opportunity to decide him/herself which goods and/or services come into question for retrieval. Convenience for the user, and also security, for example for protecting children from inappropriate goods and/or services, are increased via this option.

It may be provided that in a starting state, all available authorizations are initially deactivated, and in each case an activation is necessary before the goods and/or services may be retrieved. Alternatively, it may be provided that in the starting state, all available authorizations are activated, and the service recipient may deactivate individual authorizations, depending on his/her own preferences.

In addition, it may be provided that multiple authorizations may be activated and/or deactivated only jointly. This ensures in a particularly advantageous manner that all complementary goods and/or services that pertain to a main good or main service are available. For example, dispensing coffee may be a main good. As a complement, however, generally the authorization to retrieve sugar and milk is also desired. In this example, it may be provided that the authorizations for retrieving coffee, sugar, and milk are activatable and/or deactivatable only jointly, corresponding to the configuration described above. A situation in which the service recipient would like to retrieve a complementary good and/or complementary service that is self-evident for the service recipient, but is denied to him/her, may thus be effectively avoided.

Furthermore, it may be provided that after the information carrier of the physical object is read by a mobile terminal, the authorizations may be accessed independently of the physical object, in particular regardless of the ownership of the physical object. In other words, an at least partial copy of the information carrier may be stored in the mobile terminal to allow access to associated authorizations only by use of the mobile terminal, even without the physical object. Only object-related data are stored on the mobile terminal, namely, data of the information carrier of the physical object. Data that allow the identity of a certain person to be known are not necessary for accessing the authorizations. Anonymity is thus advantageously ensured. Moreover, the service recipient of the goods and/or services may be an actor who is different from the owner of the physical object. In addition, it may be provided that the data of the information carrier may be exchanged, in particular sent, between mobile terminals. Furthermore, it may be provided that multiple mobile terminals simultaneously read in and locally store the data of the information carrier of the same physical object. This always involves object-related data, i.e., data, for example the identifier, that are/is associated with the physical object.

The physical object may thus advantageously be stored, without the need to carry it along for retrieving goods and/or services. This also advantageously allows an authorization that may be accessed by an owner of the physical object to also be made available to the owner's friends. A convenient option is provided for allowing third parties to make the retrieval, in particular when the owner of the physical object him/herself is not interested in retrieving the goods and/or services pertaining to the authorization.

According to embodiments of the present invention, only object-related data, in particular the identifier UID, are/is necessary for the retrieval. Authorizations that are stored in a digital representation in an IoT platform are thus accessed, and the identifier allows the unequivocal assignment of the physical objects and the digital representations. It is particularly advantageous that data via which the identity of persons could be revealed are not necessary.

The method according to the invention may further include:
configuring the authorization profile of the digital representation, the establishment of the authorization profile including:
   i) adding at least one authorization to the authorization profile of the digital representation, and/or
   ii) removing at least one authorization from the authorization profile of the digital representation.

A configurably designed authorization profile is particularly advantageous with regard to variability and flexibility. Authorizations may thus be added or removed as needed, or depending on external circumstances. The configuration may in particular take place regardless of whether the physical objects are placed on the market.

As described above, the configuring of the authorization profile may take place either by adding authorizations or by removing authorizations. For adding authorizations, desired authorizations may advantageously be added. For removing authorizations, a plurality of authorizations may be stored in advance, during the configuration of the authorization profile it being possible to remove unwanted authorizations in a targeted manner. A particularly simple option is thus provided for storing certain authorizations in an authorization profile of a digital representation that is associated with a physical object.

Creating the digital representation and/or providing the configurable authorization profile and/or configuring the authorization profile particularly preferably take(s) place on an IoT platform.

By use of an IoT platform, which may be designed in particular as a server, cloud service, or web application, it is possible for various actors to read out, process, create, and/or delete the digital representations centrally and in real time. In particular, personal data are thus protected, since the interaction with the IoT platform for access to authorizations requires only object-related data. The authorization profiles may particularly advantageously be processed in real time. For example, if an authorization issuer has made the decision to create a certain authorization for a physical object and assign it to the particular authorization profile, the authorization issuer can access the IoT platform in real time and do this. An owner of the physical object or a service recipient with access to such an authorization that is present in the authorization profile of the particular digital representation is able to retrieve a good and/or service corresponding to the authorization, for example from a service provider, directly upon the creation/addition of the authorization in the authorization profile.

It is preferably provided that for creating the digital representation, an initially unassigned digital representation is created regardless of the existence of the physical object, it being possible to subsequently link to the physical object by means of the identifier.

As a result of the existence of the digital representation and the existence of the physical object being independent, the flexibility and variability of the method according to the invention are advantageously increased. Thus, for example, a physical object may exist or be manufactured long before a digital representation is created. It is thus possible to also subsequently create digital representations of physical objects that have already been manufactured or that have been in use for years. Conversely, digital representations that are only subsequently linked to the physical objects may be created in advance, based on a planned production of physical objects. In particular, it is thus advantageously made possible for the manufacturer and/or issuer of the physical objects and the creator of the digital representations to be different actors.

The method may further include:
issuing the physical object with the information carrier, wherein the manufacture of the physical object, the manufacture of the information carrier, and the addition of the information carrier to the physical object take place independently of one another, and are preferably carried out by at least two different actors.

A further increase in the flexibility and variability of the method is thus achieved, in that the manufacturer and/or issuer of the physical object and the manufacturer of the information carrier may be actors that are different from one another. In addition, the actor who adds the information carrier to the physical object may be a different actor. For example, a contract manufacturer A may manufacture a physical object, and a contract manufacturer B may manufacture an information carrier, while a third company C, which may, for example, be the contracting entity for contract manufacturers A and B, adds the information carrier to the physical object.

Adding the information carrier to the physical object may take place in particular using conventional fastening mechanisms, depending on the nature and the material of the physical object, and/or the information carrier. For example, it would be conceivable to adhere the information carrier to the physical object. Printing, laminating, or sewing the information carrier is also possible. Alternatively or additionally, the information carrier may be issued separately as an add-on to a physical object.

The method preferably includes the steps:
enabling the digital representation for configuring the authorization profile, the enabling being a mandatory prerequisite for configuring the authorization profile of the digital representation, and the enabling preferably including:
   a) granting permission for the configuring, preferably to certain actors, and/or
   b) establishing rules for the configuring, wherein the rules may include one or more of the following rule types:
   b1) only certain authorizations or a certain type of authorization are/is addable to the authorization profile;
   b2) only certain authorizations or a certain type of authorization are/is removable from the authorization profile;
   b3) there is a maximum limit for the number of addable authorizations;
   b4) there is a minimum limit for the number of authorizations that must remain in the authorization profile;
   b5) the addition or the removal of authorizations may take place within certain time periods and/or at certain times of day;
   b6) the addition or the removal of authorizations can take place only when a certain further condition besides the enabling of the digital representation is met.

By providing an absolutely necessary enabling step of the digital representation for configuring the authorization profile, it may be ensured that the authorization profile contains no unwanted authorizations, or whether authorizations are added at all, even though this is still unwanted or not yet permitted. For example, an issuer of physical objects may be provided as the entity that decides when and/or whether the authorization profile of the digital representation, which is assigned to the particular physical object, is allowed to be provided with authorizations or with certain authorizations. Security is thus advantageously increased, and unwanted functionalities are avoided. In this way, certain actors may be enabled to administer an authorization profile.

Particular rules may also contribute to further enhancement of the security and desired functionality. Thus, for example, for purposes of protecting children, it is possible for only certain authorizations and/or a certain type of authorization to be addable to or removable from the authorization profile. In turn, as described above, a certain actor, for example the issuer of the physical objects, may decide on the rules. It may particularly advantageously be provided that rules for the configuration are freely definable or addable, in particular addable to the digital representations. One example of such a rule is providing for the establishment of a maximum limit for the number of addable authorizations. The situation may thus advantageously be avoided that the number of available authorizations in an authorization profile becomes unclear due to their quantity. In addition, for example a rule may be provided, according to which the addition or removal of authorizations may take place only if one or more certain further conditions besides the enabling of the digital representation are met. Such a further condition may be, for example, a recorded goods turnover of the physical objects, or a certain number of sold physical objects, or the presence of an authentication identifier.

It may also be provided that the method includes:
providing an authorization pool that includes available authorizations, it being possible for authorizations of the authorization pool that are newly available to be created by an authorization issuer, who preferably is neither the owner nor the issuer of the physical object.

In addition, it may be provided that the creation of newly available authorizations of the authorization pool may be carried out by the authorization issuer, preferably by multiple authorization issuers, the authorization issuer being an actor who is different from the service provider of the goods and/or services.

It is preferably alternatively or additionally provided that the configuring of the authorization profile of the digital representation may be carried out by an authorization issuer, in particular by multiple authorization issuers, the authorization issuer being neither the owner nor the issuer of the physical object, and/or being an actor who is different from the service provider of the goods and/or services.

The configuring of the authorization profile may take place in a particularly simple manner by providing an authorization pool with available authorizations. The authorization pool may be kept in particular by an IoT platform. Various predefined authorizations, which may be used as a template for configuring the authorization profiles, may be stored in the authorization pool. The creation of newly available authorizations in the authorization pool may be carried out in particular by an authorization issuer. The authorization issuer is preferably a third party who is neither the owner nor the issuer of the physical object.

It is thus advantageously possible to provide and/or revise an authorization pool which leaves room for the creativity of third parties and allows creation of a broad spectrum of available authorizations.

Creating newly available authorizations of the authorization pool may be carried out in particular by an authorization issuer who is neither the provider of goods and/or services nor the owner or issuer of the physical objects. By keeping service providers and authorization issuers separate, it is possible for various actors to collaborate with one another. In other words, a service provider, i.e., the entity that outputs the goods and/or services, is a different actor than the authorization issuer, who adds authorizations to the authorization profile.

It is preferably provided that the configuring of the authorization profile of the digital representations takes place at least semiautomatically, in that in particular the authorizations that are available for the digital representation are automatically preselected, based on a certain feature of the digital representation, via machine learning.

The configuring is advantageously simplified by providing configuring of the authorization profile that takes place at least semiautomatically. In this way, certain authorizations that are assigned to a good and/or service and that best match the physical object may be preselected, for example as a function of the physical object or as a function of the digital representation or as a function of a stored feature in the digital representation. The at least semiautomatic configuring may in particular include outputting a list of authorizations that is sorted according to relevance, with the list of authorizations sorted in order of decreasing relevance. Authorizations whose goods and/or services have a particularly good match with the physical object in question have high relevance. The assessment of the relevance, or whether an authorization matches a particular physical object, may be advantageously assisted by machine learning. Inputs by an authorization issuer who adds certain authorizations to an authorization profile of a digital representation may be used and evaluated as training data in order to derive criteria for assessing the relevance and for the at least semiautomatic configuring (supervised machine learning).

It may be provided that a retrieval of the goods and/or services by a service recipient from a service provider is possible only when at least one predefined condition is met, it being possible in particular for the condition to be how frequently the good and/or service are/is permitted to be retrieved, at what time the good and/or service are/is permitted to be retrieved, or at what location the good and/or service are/is permitted to be retrieved.

By providing at least one predefined condition for retrieving the goods and/or services, ensuring control over the retrieval of goods and/or services is advantageously made possible. Thus, for example, it may be provided that a good and/or service having an appropriate authorization is retrievable only at certain locations, for example in certain branches of a service provider. It may also be provided, for example, that the retrieval of goods and/or services may take place only at certain times of day or on certain days of the week.

The method preferably includes:
storing a piece of retrieval information in the digital representation after a retrieval of the goods and/or services has taken place, the retrieval information preferably including information concerning whether and how often a good and/or service have/has been retrieved, and also preferably including a time stamp for each retrieval.

If a good and/or service are/is retrieved by means of an authorization, the retrieval may advantageously be tracked by storing a piece of retrieval information in the digital representation or on the IoT platform. This information may be used in particular to define and/or adapt rules that relate to the configuring of authorizations in the authorization profile, or to define and/or adapt conditions that must be met to allow goods and/or services to be retrieved.

For example, a beer glass may be a physical object that is to be washed by its owner, an innkeeper, in a dishwasher and subsequently refilled with beer. In this case the dishwasher is a first output device with a reading device that is able to read the information carrier of the beer glass. In addition, the innkeeper has a tap for filling beer glasses with beer. The tap is a second output device with a reading device that is able to read out the information carrier of the beer glass. The following procedure may take place based on the described starting situation: The innkeeper places the beer glass in the dishwasher. The dishwasher reads the information carrier of the beer glass and detects the object-related identifier UID. Based on the object-related identifier UID, the dishwasher, which is able to communicate with an IoT platform via a communicative connection, forms a persistent identifier PID that is designed as an internet link and contains the object-related identifier UID. Using the persistent identifier PID, the dishwasher accesses the digital representation or the authorization profile, which on the IoT platform is assigned to the beer glass or the object-related identifier UID. The dishwasher detects that an authorization for a certain washing program is present, and starts the washing program. At the start of, during, or after the washing operation, the dishwasher sends a piece of retrieval information to the IoT platform, as the result of which a verification that a wash cycle has taken place, including a time stamp, is stored in the digital representation of the beer glass. After the wash cycle has concluded, the innkeeper takes the glass from the dishwasher and places it under the tap. The beer glass has just been removed from the dishwasher, and consequently has a temperature that is greatly above room temperature. The tap with its reading device reads the information carrier of the beer glass, and accesses the digital representation or the authorization profile in the same way as the dishwasher. There, the tap finds the authorization for dispensing beer; however, this authorization additionally contains a condition that must be met so that the authorization can be used and the tap can dispense beer. The condition states that when a wash cycle has been carried out, a certain time period must elapse before beer is dispensed. The tap denies the dispensing of beer, or starts it only after the time period has elapsed. The time period may be predefined, and based on the time stamp it may be checked whether the time period has already elapsed. The time period may be predefined as a function of the particular washing program. It is thus ensured that beer is dispensed only in cooled beer glasses, so that enjoyable drinking of the beer is guaranteed.

Several embodiments of the present invention share the common feature that a service recipient, who possibly is also the owner of a physical object, may disclose no data that directly reveals his/her identity. Thus, for example, it is conceivable that an owner of a coffee cup, which is provided with an information carrier and an authorization for retrieving coffee from a service provider, may take this coffee cup to a service provider and receive coffee at an output device, for example a coffee machine.

According to the present invention, a digital representation of a physical object is also provided, the digital representation being stored in an IoT platform and configured for use in a method described above.

According to the invention, an IoT platform or reading device, which is preferably designed as a mobile terminal or provided [as an] output device, is also configured to carry out particular steps of the method described above.

According to the present invention, an output device of goods and/or services is also provided, the output device including a reading device and preferably being designed as a beverage vending machine, the output device being configured and designed to carry out particular steps of the method described above. In particular an NFC or RFID interface, a camera, or the like may be provided as a reading device.

According to the invention, in addition a computer program is provided that includes commands which, when the program is executed by a computer, prompt the computer to carry out particular steps of the method described above.

The technical advantages and embodiments described with regard to the method according to the invention equally apply to the digital representation according to the invention, to the IoT platform or reading device according to the invention, to the output device of goods and/or services, and to the computer program.

### BRIEF DESCRIPTION OF THE DRAWINGS

Preferred embodiments of the present disclosure are described below with reference to the following figures:

FIG. 1 shows a first schematic illustration of embodiments of the present invention.

FIG. 2 shows a second schematic illustration of embodiments of the present invention.

FIG. 3 shows a third schematic illustration of embodiments of the present invention.

FIG. 4a shows a schematic illustration of an output of goods and/or services by an output unit that communicates with an IoT platform, according to embodiments of the present invention.

FIG. 4b shows a schematic illustration of an output of goods and/or services by an output unit, with a local authorization memory according to embodiments of the present invention.

FIG. 5 schematically shows reading in of an authorization by a mobile terminal according to embodiments of the present invention.

FIG. 6a shows a mobile terminal with available authorizations according to embodiments of the present invention.

FIG. 6b shows a mobile terminal with available authorizations and an activated authorization according to embodiments of the present invention.

FIG. 7 shows one possible design of a web application of a corresponding IoT platform according to embodiments of the present invention.

### DESCRIPTION OF PREFERRED EXEMPLARY EMBODIMENTS

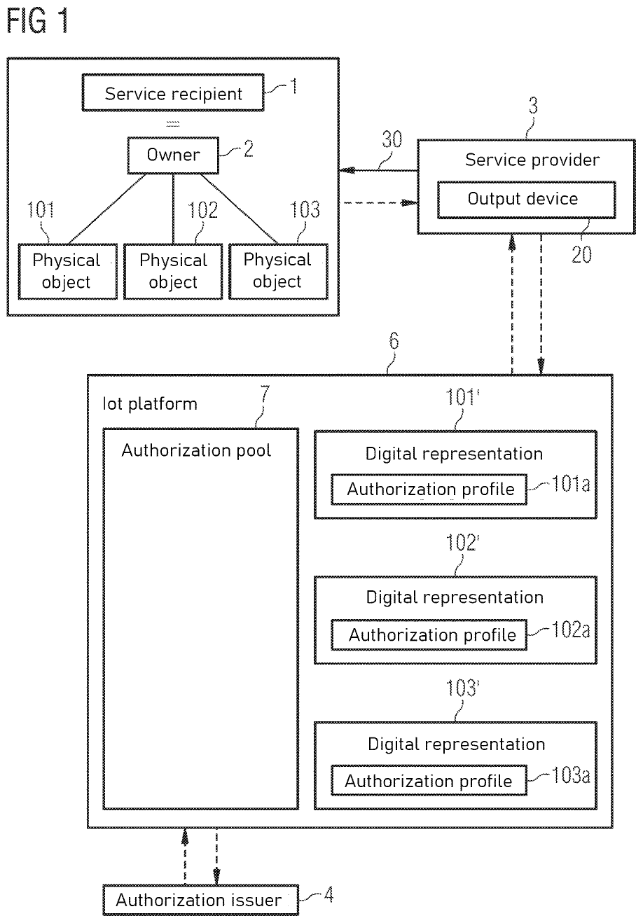

According to the embodiment of the present invention illustrated in FIG. 1, an IoT platform 6 that includes an authorization pool 7 and digital representations 101′, 102′, 103′ is provided. The digital representations 101′, 102′, 103′ are each unique representations of respective physical objects 101, 102, 103. The physical objects 101, 102, 103 include an information carrier I with a unique identifier UID stored thereon, via which a particular physical object 101, 102, 103 is unequivocally assignable to its digital representation 101′, 102′, 103′. Conversely, the particular digital representation 101′, 102′, 103′ of a physical object 101, 102, 103 may be unequivocally assigned to the respective physical object 101, 102, 103 by means of a corresponding identifier UID that is also stored in the digital representation 101′, 102′, 103′. For example, the digital representation 101′ is the representation of the physical object 101, the digital representation 102′ is the representation of the physical object 102, and the digital representation 103′ is the representation of the physical object 103.

The IoT platform 6 provides an authorization pool 7. The authorization pool 7 includes preconfigured authorizations for retrieving goods and/or services. Preconfigured authorizations may be added to the authorization pool 7 as desired, preconfigured authorizations may be removed from the authorization pool 7, and preconfigured authorizations of the authorization pool 7 may be processed. The addition or removal of authorizations to or from the authorization pool 7 may be carried out in particular by an authorization issuer 4. For this purpose, the authorization issuer 4 accesses the IoT platform 6 and independently makes any desired adaptations to the authorization pool 7. For adapting the authorization pool 7 by an authorization issuer 4, it may be necessary for the authorization issuer 4 to perform a separate authentication in order to check whether or not an adaptation of the authorization pool 7 by the particular authorization issuer 4 is permissible.

An authorization profile 101a, 102a, 103a for each digital representation 101, 102, 103 [sic; 101′, 102′, 103′] is also provided on the IoT platform. Authorizations for retrieving goods and/or services 30 may be present in the particular authorization profiles 101a, 102a, 103a. The authorization profiles 101a, 102a, 103a of the respective digital representations 101, 102, 103 [sic; 101′, 102′, 103′] include selected authorizations that are specifically linked for the particular digital representation 101′, 102′, 103′ or for the particular physical object 101, 102, 103 that is associated with the respective digital representation 101′, 102′, 103′. An authorization profile 101a, 102a, 103a may, for example, be at least semiautomatically filled with authorizations from the authorization pool 7, or authorizations from the authorization profile 7 may be actively added to an authorization profile 101a, 102a, 103a, by an authorization issuer 4. In the case of a preconfigured authorization profile 101a, 102a, 103a that already contains authorizations, authorizations may be removed therefrom, in particular by an authorization issuer 4. Desired authorizations may thus be entered into an authorization profile 101a, 102a, 103a or removed from an authorization profile 101a, 102a, 103a in a simple manner. An authorization profile 101a, 102a, 103a may in particular be adapted by an authorization issuer 4. The authorization issuer may preferably also create and add new authorizations that previously were not present in the authorization pool 7.

The IoT platform 6 manages the access rights and/or processing rights that an authorization issuer 4 has with regard to the authorization pool 7 and/or authorization profiles 101a, 102a, 103a. Thus, certain authorization issuers 4 may be allowed to process the authorization profiles 101a, 102a, 103a of certain digital representations 101′, 102′, 103′, although the authorization issuer is denied processing of the authorization pool 7. In addition, certain authorization issuers may be allowed to adapt only the authorization pool 7. The accessing and/or the processing of authorization profiles 101a, 102a, 103a and/or the authorization pool 7 may alternatively or additionally be carried out by a service provider 3. A service provider may be any actor who outputs or markets the goods and/or services 30.

The service provider 3 may in particular have an output device 20 via which a good and/or service are/is output to a service recipient 1 when an appropriate authorization of the service recipient 1 is present. To check whether an appropriate authorization of the service recipient 1 is present, the output device 20 may communicate with the IoT platform 6 or have an internal authorization memory 21 in which the authorizations, which may be used for retrieving goods and/or services 30, are stored.

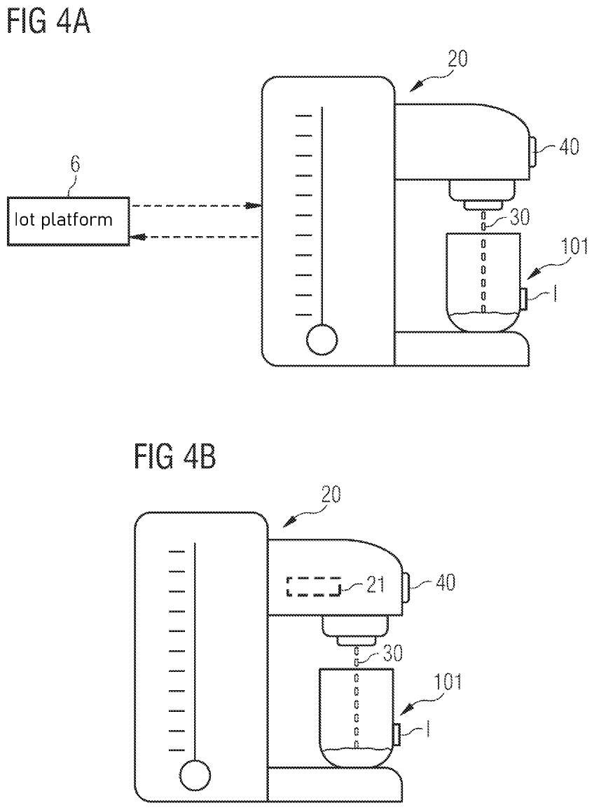

In the embodiment schematically illustrated in FIG. 1, the service recipient 1 and the owner 2 of the physical objects 101, 102, 103 are the same actor. The service recipient 1 or owner 2 carries the physical objects 101, 102, 103 with him/her. Each physical object 101, 102, 103 has an information carrier I with an identifier UID via which the particular physical objects 101, 102, 103 are unequivocally assignable to a corresponding digital representation 101′, 102′, 103′ in the IoT platform 6. To retrieve a good and/or service 30, the information carrier I is presented to the service provider 3 and/or to the output device 20. The service provider 3 may read in the information carrier I using a reading device 40, for example a mobile terminal of the service provider 3 (see FIG. 5). Alternatively, the output device 20 has a reading device 40 and reads the information carrier (see FIGS. 4a and 4b). The read-out identifier UID may subsequently be used to access the IoT platform 6 and retrieve an appropriate authorization from the authorization profile 101a, 102a, 103a of the respective digital representation 101′, 102′, 103′, or to check whether authorizations that are assigned to the identifier UID are present on the IoT platform. If the output device 20 has an internal authorization memory 21 (see FIG. 4b), the authorizations may be checked without communication with the IoT platform 6. For this purpose, the digital representations and/or authorization profiles are locally stored in the authorization memory 21 in advance, i.e., prior to the retrieval of a service. In the case in which the output device 20 communicates with the IoT platform 6 in order to check the authorizations, the output device 20 preferably converts the identifier UID into a persistent identifier PID. The persistent identifier PID may particularly advantageously include or be formed from the identifier UID, which in particular is designed as a unique identifier, to allow an unequivocal assignment to a digital representation 101′, 102′, 103′ via a data network. A mobile radio communications network, for example, may be used as a data network. The persistent identifier PID may in particular be designed as an internet link, so that the output device 20 may access the digital representation 101′, 102′, 103′ or the authorization profile 101a, 102a, 103a of the respective digital representation 101′, 102′, 103′ via the internet in order to check the presence of any authorization for the particular physical object 101, 102, 103 and to make a decision about whether a requested good and/or service 30 is output.

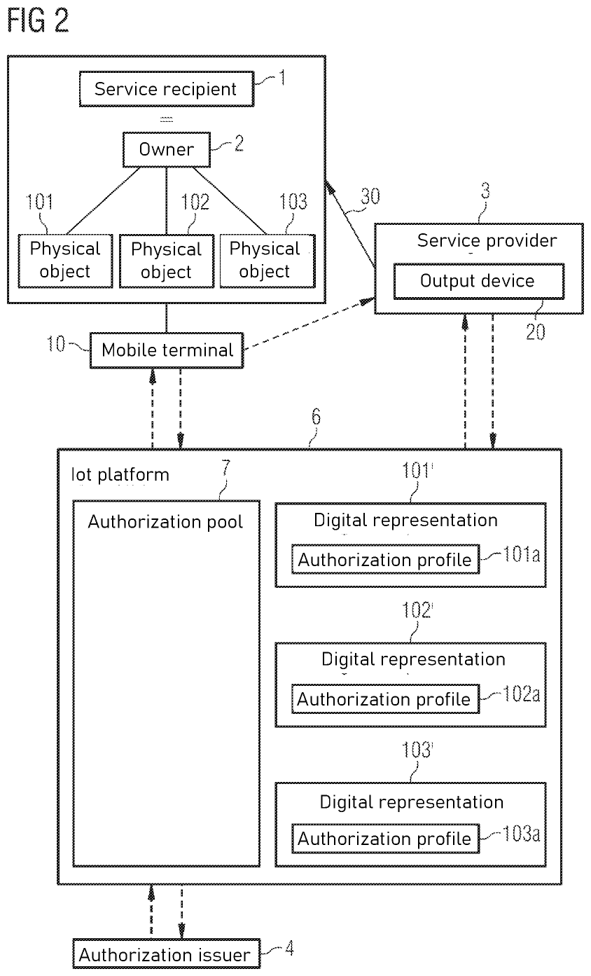

In the configuration schematically illustrated in FIG. 2, the service recipient 1, the same as in FIG. 1, is the same actor as the owner 2. In contrast to the configuration in FIG. 1, the service recipient 1 or owner 2 carries a mobile terminal 10 with him/her, in that the identifier UIDs of the physical objects 101, 102, 103 are stored. For this purpose, the information carrier I of the physical objects 101, 102, 103 has been read out in advance using a reading device 40 of the mobile terminal 10. The physical objects 101, 102, 103 are no longer necessary for retrieving goods and/or services 30 from the output device 20, since the identifiers UID of the physical objects 101, 102, 103 are now stored on the mobile terminal 10. The mobile terminal 10 may thus send requests or identifier UIDs to the output devices 20 or to the service provider 3 to obtain a good and/or service 30. It may be advantageously provided that the mobile terminal 10 stores and/or transfers only object-related information, i.e., the identifier UID, so that in principle it replaces only the existence or the presence of the physical object 101, 102, 103. The mobile terminal 10 may in particular communicate with the IoT platform 6, preferably via a mobile data network, in order to access the authorizations from the digital representations 101′, 102′, 103′ of the respective physical objects 101, 102, 103. A reading device 40 of the mobile terminal 10, which may be designed as a camera or as an NFC or RFID reader, for example, detects the identifier UID on the information carrier I of the physical objects 101, 102, 103. A persistent identifier PID, which is preferably designed as an internet link and in particular may include the particular identifier UIDs, is subsequently created from the particular identifier UIDs. The mobile terminal 10 accesses the IoT platform 6 via an internet connection by calling up the internet link. The mobile terminal 10 is thus led directly to the appropriate digital representation 101′ and may access the authorization profile 101a.

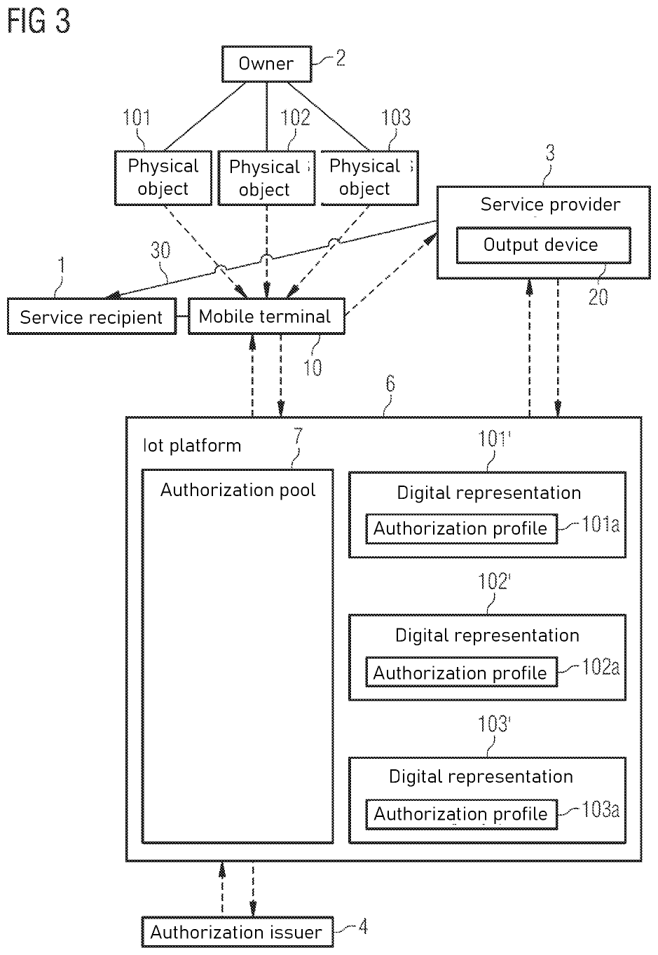

In the configuration schematically illustrated in FIG. 3, the service recipient 1 and the owner 2 are different actors. The owner 2 owns the physical objects 101, 102, 103, but for example has no interest him/herself in retrieving goods and/or services 30 that are associated with authorizations. The service recipient 1 owns a mobile terminal 10 that can communicate with the IoT platform 6, preferably via a mobile data network. By use of the mobile terminal 10, which has a reading device 40 that may be designed as a camera or as an NFC or RFID reader, for example, the service recipient 1 reads the information carrier I of the physical objects 101, 102, 103 or the identifiers UID on the information carriers I of the particular physical objects 101, 102, 103. Via the communicative connection of the mobile terminal 10 to the IoT platform 6, the mobile terminal 10 accesses the digital representations 101′, 102′, 103′ or their respective authorization profiles 101a, 102a, 103a, which are unequivocally assignable to the physical objects 101, 102, 103, and stores the authorizations, stored in the respective authorization profiles 101a, 102a, 103a, in a local memory of the mobile terminal 10. As an alternative to storing on a local memory of the mobile terminal 10, for further use the mobile terminal 10 may retrieve the data in real time via the communicative connection to the IoT platform 6; i.e., the data would then be available to the mobile terminal 10 only for retrieval (on demand). As an alternative to storing authorizations on the mobile terminal 10 or accessing authorizations by the mobile terminal 10, it is possible to store only the identifier UID on the mobile terminal 10 in order to present it to an output device 20 or to a service provider 3, so that the output device 20 or the service provider 3 retrieves or checks the authorizations for the particular physical object 101, 102, 103 by communicating with the IoT platform 6.

The mobile terminal 10 may now be used independently of the physical objects 101, 102, 103 for retrieving goods and/or services 30, in particular from a service provider 3 and/or an output device 20. For retrieving or checking the authorizations, the output device 20 may have or establish a communicative connection to the IoT platform 6 and/or may have a local authorization memory 21. The checking for whether a valid authorization of the mobile terminal 10 is present takes place either when an authorization is presented, or by comparing the presented authorization to the authorizations on the IoT platform 6 or to the authorizations of the output device 20 stored in the local authorization memory 21. Alternatively, if an identifier UID is presented, the checking takes place in the form of an access to the IoT platform 6, wherein the authorizations stored in the corresponding authorization profile 101a, 102a, 103a of the respective digital representation 101′, 102′, 103′ of the associated physical object 101, 102, 103 are retrieved. In this configuration the mobile terminal 10 acts solely as a carrier of the authorizations and/or as a carrier of the identifier. As a carrier of the identifier UID, in this sense the mobile terminal replaces the physical object 101, 102, 103, or more precisely, replaces the identifier UID stored on the information carrier I of a physical object 101, 102, 103. Further data that could reveal the identity of a certain person are advantageously not necessary. In this regard, the object-related information concerning the particular physical object is sufficient. If an authorization is present in the authorization profile 101a, 102a, 103a, a good and/or service 30 are/is output and the service recipient 1 may receive them/it.

FIG. 4a shows an output device 20 designed as a coffee machine, with a reading device 40 and a communicative connection to an IoT platform 6. The communicative connection to the IoT platform 6 is preferably a connection via a mobile data network. For this purpose, the output device 20 may be integrated into a Wi-Fi network 1 of a service issuer 3. In the situation illustrated in FIG. 4a, a good 30, in the present case coffee, is dispensed. A physical object 101, in the present case designed as a coffee cup, having an information carrier I has been inserted, in particular by a service recipient 1, into a receiving area of the output device 20 for receiving coffee. An identifier UID, which in particular may be designed as a unique identifier, is stored on the information carrier I. For this purpose, the information carrier I may be a QR code, a barcode, an NFC chip, or an RFID chip, for example. The issuer of the physical object 101, the issuer of the information carrier I, and the issuer of the physical object 101 equipped with the information carrier I are in particular at least two different actors.

In contrast to the configuration depicted in FIG. 4a, the output device 20 in FIG. 4b, designed as a coffee machine, has an internal authorization memory 21. The internal authorization memory 21 allows the output device 20 to function even without a communicative connection to the IoT platform 6. Necessary data that are retrieved via the IoT platform 6 in the configuration in FIG. 4a may be stored offline on the authorization memory 21 in the configuration in FIG. 4b. The storing of the necessary authorizations on the internal authorization memory 21 may be carried out in particular by a temporary communicative connection to the IoT platform 6 that is established beforehand. Alternatively or additionally, the service provider 3 may store data on the internal authorization memory 21 of the output device 20 in some other way, in particular via a data transfer interface (USB, SD, micro SD, nano SD), at any given point in time. By providing an internal authorization memory 21, the functionality of the output device 20 may also be advantageously ensured when a communicative connection to an IoT platform 6 is not possible or is unwanted, in particular during operation of an output device in so-called “dead spots.”

The reading device 40 of the output device 20 is configured and designed to read in an information carrier I of a physical object 101. Depending on the type and nature of the information carrier I, the reading device 40 is a camera and/or an NFC or RFID interface, for example. The reading device 40 may also be designed to communicate with mobile terminals 10 via conventional data transfer interfaces, for example Bluetooth or Wi-Fi. The functionality may thus be ensured in a case in which the identifier UID is presented via a mobile terminal 10, not via a physical object 101. In particular, a good and/or service 30 may be output even if the physical object 101 is not carried along or is not to be presented. Alternatively or additionally, for the reading device 40 it may be provided that a service provider 3 has a mobile terminal 10 with which the information carrier I or the identifier UID may be read in. The decision as to whether or not a good and/or service 30 is output may thus be made outside the output device 20, for example by a mobile terminal 10 of a service provider 3. After the authorization is checked, the service provider 3 may operate the output device 20 manually and thus bring about the outputting of a good and/or service.

FIG. 5 schematically illustrates a situation in which a mobile terminal 10 reads in an information carrier I of a physical object 101 using a reading device 40. The mobile terminal 10 communicates with an IoT platform 6, concurrently or with a time delay, for example to retrieve or check any authorizations that are present in the authorization profile 101a, 102a, 103a of a digital representation 101, 102, 103 [sic; 101′, 102′, 103′] of a respective physical object 101, 102, 103. The mobile terminal 10 may be a mobile terminal 10 of an owner 2 of a physical object 101, 102, 103, a mobile terminal 10 of a service recipient 1 of goods and/or services 30, or a mobile terminal 10 of a service provider 3 for checking authorizations. If the mobile terminal 10 is a mobile terminal 10 of an owner 2 of physical objects 101, 102, 103, or is a mobile terminal 10 of a service recipient 1, the mobile terminal 10 is used only as a carrier of the identifier UID. After the identifier UID has been read in by the reading device 40 of the mobile terminal 10, it may be used via existing communication interfaces of the mobile terminal 10, for example Bluetooth interfaces, Wi-Fi interfaces, NFC interfaces, or via a display device for displaying a visual data code (QR code, for example). In other words, in this configuration the mobile terminal 10 may replace a physical object 101, 102, 103 so that it does not have to be carried along. If the mobile terminal 10 is a mobile terminal 10 of a service provider 3, it is possible for the service provider 3 to check and/or retrieve any authorizations that are present in an authorization profile 101a, 102a, 103a of a digital representation 101, 102, 103 of a respective physical object 101, 102, 103. It is thus possible for the service provider 3 to use nonlinked output devices 20 in order to offer goods and/or services 30.

It is also conceivable for the mobile terminal 10 to be a mobile terminal 10 of an authorization issuer 4, it being possible for the authorization issuer 4 to check authorizations that are stored in the authorization profile 101a, 102a, 103a. The checking may be desirable in particular when there is doubt as to whether changes made on the IoT platform 6 have been stored in the particular authorization profiles 101a, 102a, 103a.

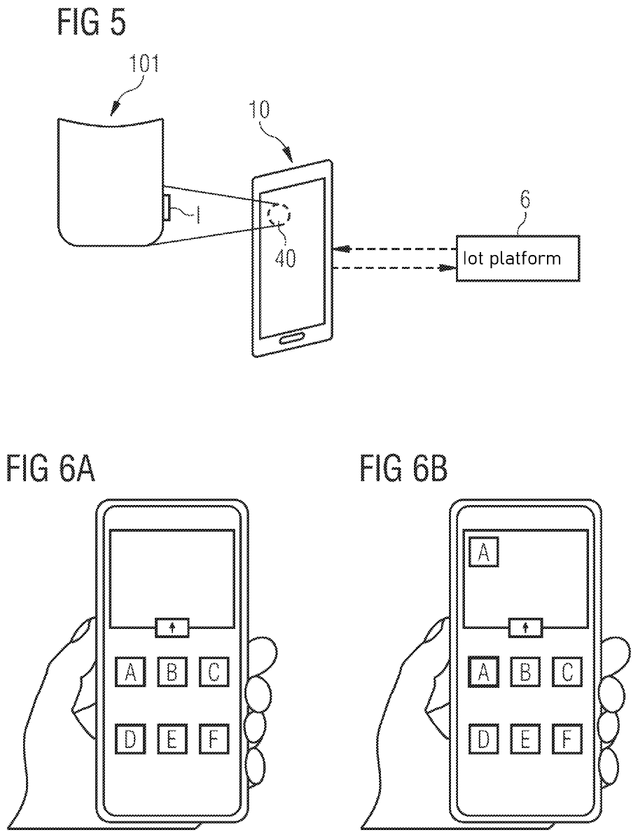

FIGS. 6a and 6b illustrate a mobile terminal 10 which, in each of the illustrated situations, has read in an identifier UID and accesses the IoT platform 6 or an authorization profile 101a, 102a, 103a. Available authorizations A, B, C, D, E, F that are assigned to the read-in identifier ID are displayed In FIG. 6a. These authorizations are positioned in the lower area of the display device of the mobile terminal 10 in order to visually display to a user of the mobile terminal 10 that these are unactivated authorizations from the authorization profile 101a, 102a, 103a. For activating the available authorizations, it is possible for the user of the mobile terminal 10 to touch an authorization from the lower area of the display device of the mobile terminal 10 and/or to drag it into the field of the display device of the mobile terminal 10 illustrated at the top. This is generally referred to as “swiping.” In the state illustrated in FIG. 6b, the authorization A is activated and is thus situated in the upper area of the display device of the mobile terminal 10. All other authorizations B, C, D, E, F remain unactivated. As the result of providing the option to activate and/or deactivate authorizations, a user of the mobile terminal 10 is advantageously enabled to freely decide which available authorizations he/she would like to use for retrieving goods and/or services 30. Thus, for example, an owner 2 of a physical object 101, 102, 103 or a service recipient 1 may be provided with free and individual control over which authorizations he/she would like to activate. Preferences of owners 2 or service recipients 1 are thus advantageously taken into account. The option of activating and/or deactivating authorizations further increases the security of the method according to the invention, for example with regard to child protection directives. It is particularly advantageous when all activations/deactivations take place on the IoT platform 6, and not locally on the mobile terminal 10. In this case, the mobile terminal 10 is referred to in simple terms as the “window for looking into the IoT platform 6.” Alternatively or additionally, the activations/deactivations may be stored locally on the mobile terminal.

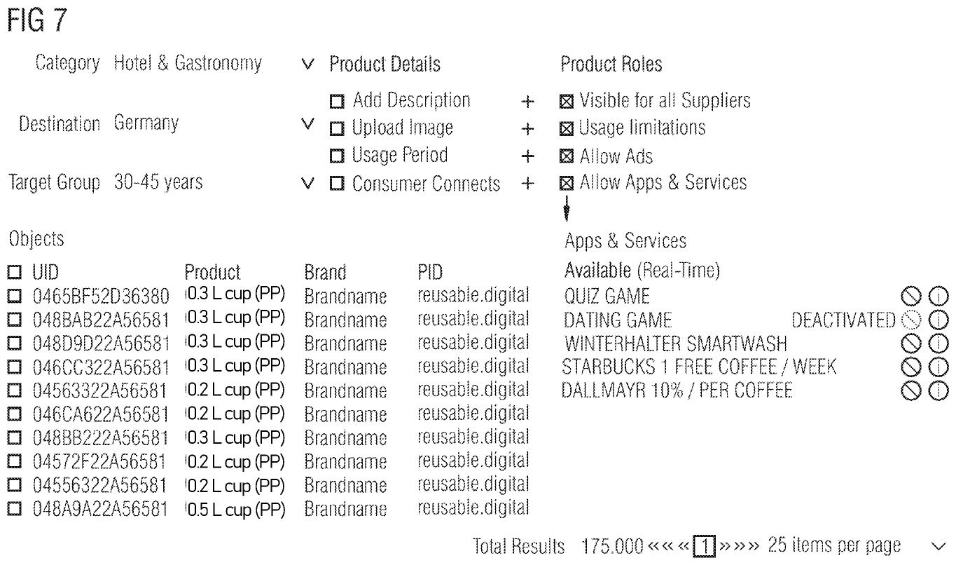

FIG. 7 shows one possible design of a web application of a corresponding IoT platform 6 according to embodiments of the present invention.

Various use scenarios of the present invention are explained below, but are not limited thereto:

A.

An end user purchases a reusable coffee cup in a local retail store. The end user thus becomes the owner 2 of the coffee cup, which in this case represents a physical object 101. The coffee cup has an information carrier I that is designed as a QR code. The QR code includes an identifier UID via which the coffee cup or the physical object 101 is unequivocally assignable to a digital representation 101′ on an IoT platform 6. The digital representation 101′ of the coffee cup has been created beforehand, for example at the time the coffee cup was manufactured. The authorization for retrieving coffee has been stored in the corresponding digital representation 101′ in the particular authorization profile 101a by an authorization issuer 4. The authorization issuer 4 may be the service provider 3, or may be a third party who, for example, cooperates with the service provider 3 or pays for the services of the service provider 3. The owner 2 of the coffee cup, using his/her authorization, would now like to retrieve coffee, which in the present case is the good 30, from an appropriate service provider 3. To retrieve the coffee, the service recipient 1 or owner 2 takes his/her physical object 101 to the service provider 3. The service provider 3 has a coffee machine, which in the present case is the output device 20. The output device 20 includes a reading device 40 via which the information carrier I is read out. No data are transferred which could reveal the identity of the service recipient 1 or the owner 2. This involves strictly object-related data, i.e., data that unequivocally identify the physical object 101, which in the present case is a coffee cup, and allow an assignment to a certain associated digital representation 101′. In addition, the output device 20 is in communicative connection with the IoT platform 6. The service recipient 1 or owner 2 places his/her coffee cup in the coffee machine, and the reading device 40 detects the identifier UID on the information carrier I of the coffee cup. A persistent identifier PID which is designed as an internet link and which in particular may include the identifier UID is subsequently created from the identifier UID. The coffee machine accesses the IoT platform 6 via an internet connection by calling up the internet link. The coffee machine is thus led directly to the appropriate digital representation 101′, and may access the authorization profile 101a in order to retrieve the authorization. If an authorization is present, the coffee is dispensed.

B.

An end user purchases a reusable coffee cup in a local retail store. The end user thus becomes the owner 2 of the coffee cup, which in this case represents a physical object 101. The coffee cup has an information carrier I that is designed as a QR code. The QR code includes an identifier UID via which the coffee cup or the physical object 101 is unequivocally assignable to a digital representation 101′ on an IoT platform 6. The digital representation 101′ of the coffee cup has been created beforehand, for example at the time the coffee cup was manufactured. The authorization for retrieving coffee has been stored in the corresponding digital representation 101′ in the particular authorization profile 101a by an authorization issuer 4. The authorization issuer 4 may be the service provider 3, or may be a third party who, for example, cooperates with the service provider 3 or pays for the services of the service provider 3. The owner 2 of the coffee cup, using his/her authorization, would now like to retrieve coffee, which in the present case is the good 30, from an appropriate service provider 3. The owner has a mobile terminal 10 with a reading device 40 via which the information carrier I of the coffee cup may be read in. The owner reads in the information carrier using his/her mobile terminal 10, and the identifier UID is transferred to the mobile terminal 10. The mobile terminal 10 thus becomes the carrier of the identifier UID, so that it may now be used, just like the coffee cup itself, for retrieving the coffee good from a service provider 3 or an output device 20. Thus, the coffee cup is no longer necessary for the retrieval. To retrieve the coffee, the service recipient 1 goes, without his/her coffee cup, to the service provider 3. The service provider 3 has a coffee machine, which in the present case is the output device 20. The output device 20 includes a reading device 40 via which the information carrier I is read out. No data are transferred which could reveal the identity of the service recipient 1. This involves strictly object-related data, i.e., data that unequivocally identify the physical object 101, which in the present case is a coffee cup, and allow an assignment to a certain associated digital representation 101′. In addition, the output device 20 is in communicative connection with the IoT platform 6. The service recipient 1 presents his/her mobile terminal 10 to the coffee machine, and the reading device 40 detects the identifier UID on the mobile terminal 10. A persistent identifier PID which is designed as an internet link and which in particular may include the identifier UID is subsequently created from the identifier. The coffee machine accesses the IoT platform 6 via an internet connection by calling up the internet link. The coffee machine is thus led directly to the appropriate digital representation 101′, and may access the authorization profile 101a in order to retrieve the authorization. If an authorization is present, the coffee is dispensed.

C.

An end user purchases a reusable coffee cup in a local retail store. The end user thus becomes the owner 2 of the coffee cup, which in this case represents a physical object 101. The coffee cup has an information carrier I that is designed as a QR code. The QR code includes an identifier UID via which the coffee cup or the physical object 101 is unequivocally assignable to a digital representation 101′ on an IoT platform 6. The digital representation 101′ of the coffee cup has been created beforehand, for example at the time the coffee cup was manufactured. The authorization for retrieving coffee has been stored in the corresponding digital representation 101′ in the particular authorization profile 101a by an authorization issuer 4. The authorization issuer 4 may be the service provider 3, or may be a third party who, for example, cooperates with the service provider 3 or pays for the services of the service provider 3. The owner 2 of the coffee cup does not want to retrieve coffee himself because he does not drink coffee, and has purchased the coffee cup only to use it as a pen holder on a desk. However, the wife of the owner 2 likes to drink coffee very much, and the owner 2 and the wife of the owner 2 would like for the wife of the owner 2 to be able to retrieve the coffee. The wife of the owner 2 is thus to become a service recipient 1. The owner has a mobile terminal 10 with a reading device 40 via which the information carrier I of the coffee cup may be read in. The service recipient reads in the information carrier using her mobile terminal 10, and the identifier UID is transferred to the mobile terminal 10. The mobile terminal 10 thus becomes the carrier of the identifier UID, so that it may now be used, just like the coffee cup itself, for retrieving the coffee good from a service provider 3 or an output device 20. Thus, the coffee cup is no longer necessary for the retrieval. To retrieve the coffee, the service recipient 1 goes, without the coffee cup, to the service provider 3. The service provider 3 has a coffee machine, which in the present case is the output device 20. The output device 20 includes a reading device 40 via which the information carrier I is read out. No data are transferred which could reveal the identity of the service recipient 1. This involves strictly object-related data, i.e., data that unequivocally identify the physical object 101, which in the present case is a coffee cup, and allow an assignment to a certain associated digital representation 101′. In addition, the output device 20 is in communicative connection with the IoT platform 6. The service recipient 1 presents her mobile terminal 10 to the coffee machine, and the reading device 40 detects the identifier UID on the mobile terminal 10. A persistent identifier PID which is designed as an internet link and which in particular may include the identifier UID is subsequently created from the identifier UID. The coffee machine accesses the IoT platform 6 via an internet connection by calling up the internet link. The coffee machine is thus led directly to the appropriate digital representation 101′, and may access the authorization profile 101a in order to retrieve the authorization. If an authorization is present, the coffee is dispensed

D.

At an inn in which an innkeeper serves customers beer in beer glasses, the following may be provided: A beer glass may be a physical object 101 with an information carrier I on which an identifier UID of the beer glass is stored. The owner of the beer glass is the innkeeper. The innkeeper washes his/her beer glass in a dishwasher, and subsequently refills it with fresh beer in order to serve it to customers. In this case the dishwasher is a first output device 20 with a reading device 40 that is able to read the information carrier I of the beer glass. In addition, the innkeeper has a tap for filling beer glasses with beer. The tap is a second output device 20 with a reading device 40 that is able to read the information carrier I of the beer glass. The following procedure may take place based on the described starting situation: The innkeeper places the beer glass in the dishwasher. The dishwasher reads the information carrier I of the beer glass and detects the object-related identifier UID. Based on the object-related identifier UID, the dishwasher, which is able to communicate with an IoT platform 6 via a communicative connection, forms a persistent identifier PID that is designed as an internet link and contains the object-related identifier UID. Using the persistent identifier PID, the dishwasher accesses the digital representation 101′ or the authorization profile 101a, which on the IoT platform 6 is assigned to the beer glass or the object-related identifier UID. The dishwasher detects that an authorization for a certain washing program is present, and starts the washing program. At the start of, during, or after the washing operation, the dishwasher sends a piece of retrieval information to the IoT platform 6, as the result of which a verification that a wash cycle has taken place, including a time stamp, is stored in the digital representation 101′ of the beer glass. After the wash cycle has concluded, the innkeeper takes the glass from the dishwasher and places it under the tap. The beer glass has just been removed from the dishwasher, and consequently has a temperature that is greatly above room temperature. The tap with its reading device 40 reads the information carrier I of the beer glass, and accesses the digital representation 101′ or the authorization profile 101a in the same way as the dishwasher. There, the tap finds the authorization for dispensing beer; however, this authorization additionally contains a condition that must be met so that the authorization can be used and the tap dispenses beer. The condition states that when a wash cycle has been carried out, a certain time period must elapse before beer is dispensed. The tap denies the dispensing of beer, or starts it only after the time period has elapsed. The time period may be predefined, and based on the time stamp it may be checked whether the time period has already elapsed. The time period may be predefined as a function of the particular washing program. It is thus ensured that beer is dispensed only in cooled beer glasses, so that enjoyable drinking of the beer is guaranteed.

Further examples are summarized briefly:

E.

A merchandizing product or fan article, such as a T-shirt, may be provided with a sewn-in information carrier I via which certain goods and/or services (free drinks, raffle participation, or the like) may be retrieved at a festival, for example.

F.

A textile may have a sewn-in information carrier I. When the textile is put into a washing machine to be washed, a reading device of the washing machine detects the information carrier, and from the digital representation 101′ retrieves the correct wash cycle based on the correspondingly stored authorization in the authorization profile 101a. For example, the durability of the textile may be increased in this way.

G.

Object-related mixing of intermediate products may be achieved by use of the method according to the invention. Filling quantities and/or metering rates of certain components of a product to be mixed may thus be output by a dispensing device, based on stored authorizations. It would be conceivable, for example, to use the method for pharmaceutical preparation in pharmacies, where mixing vessels may be physical objects 101, 102, 103 within the meaning of the present invention. It is also conceivable to use the method for mixing cereals, nutritional supplements, or fitness drinks.

H.

In the handling of sensitive intermediate products and/or products that are moved in transport containers in the context of logistics, it may be desirable to allow the sensitive intermediate products and/or products to be moved, i.e., exposed to vibrations, for only a certain period of time. By use of the method according to the invention, specific authorizations for transport containers, which may be physical objects 101, 102, 103 within the meaning of the present invention, may be stored, via which so-called “track-and-trace” logistics are established. A conveyor belt reads the information carrier I of a transport container, accesses the authorization, and acts as specified. For example, the conveyor belt stops at certain time intervals during transport in order to give the sensitive intermediate products and/or products rest periods. The method according to the invention may be used in a particularly advantageous manner, In particular for transport of chemicals.

I.

By use of the method according to the invention and a corresponding implementation of authorizations in authorization profiles 101a, 102a, 103a of digital representations 101, 102, 103 [sic; 101′, 102′, 103′] of semi-finished products on the way to the end product, certain production machines may read in the information carrier I of the semi-finished products and act as specified in the authorizations. In particular, a certain sequence of processing steps may be set. Alternatively or additionally, a “just-in-time” and/or “just-in-sequence” provision of auxiliary substances may be automatically triggered by reading authorizations of the semi-finished products. In addition, subsequent delivery processes may thus be efficiently planned and/or controlled.

### LIST OF REFERENCE SYMBOLS

1 service recipient
2 owner (of the physical objects)
3 service provider
4 authorization issuer
5 issuer (of the physical objects)
6 IoT platform
7 authorization pool
10 mobile terminal
20 output device
21 authorization memory
30 goods and/or services
40 reading device
101, 102, 103 physical objects
101′, 102′, 103′ digital representations
I information carrier
UID identifier
authorization profile 101a, 102a, 103a

1. A method for providing authorizations, linked to physical objects, for retrieving goods and/or services, including the steps:
creating a digital representation of a physical object, preferably on an IoT platform, the physical object including at least one information carrier,
the information carrier including at least one identifier, the physical object being unequivocally assignable to its digital representation, based on the identifier, and
the information carrier being readable from goods and/or services by use of a mobile terminal and/or by means of an output device (20) in order to at least partially access the particular digital representation,
providing a configurable authorization profile for the digital representation, the authorization profile including at least one authorization for retrieving goods and/or services.

2. The method according to claim 1, the method further including:
configuring the authorization profile of the digital representation, the configuring of the authorization profile including:
i) adding at least one authorization to the authorization profile of the digital representation, and/or
ii) removing at least one authorization from the authorization profile of the digital representation.

3. The method according to claim 1, wherein an owner of the physical object may access at least the authorization profile of the particular digital representation by use of the mobile terminal and/or by use of the output device of goods and/or services, and the owner of the physical object may also activate and/or deactivate authorizations as desired from the authorizations that are available in the authorization profile, wherein only activated authorizations may be used for retrieving the particular goods and/or services, and the activation and/or deactivation of the authorizations preferably take(s) place by use of a mobile terminal.

4. The method according to claim 1, wherein the at least one authorization present in the authorization profile is activatable and/or deactivatable by an owner of the physical object by use of a mobile terminal, the activation and/or deactivation of the at least one authorization taking place in the digital representation.

5. The method according to claim 1, wherein for creating the digital representation, an initially unassigned digital representation is created regardless of the existence of the physical object, it being possible to subsequently link to the physical object by means of the identifier.

6. The method according to claim 1, further including:
issuing the physical object with the information carrier, wherein the manufacture of the physical object, the manufacture of the information carrier, and the addition of the information carrier to the physical object take place independently of one another, and are preferably carried out by at least two different actors.

7. The method according to claim 1, further including:
enabling the digital representation for configuring the authorization profile, the enabling being a mandatory prerequisite for configuring the authorization profile of the digital representation, and the enabling preferably including:
a) granting permission for the configuring, preferably to certain actors, and/or
b) establishing rules for the configuring, wherein the rules may include one or more of the following rule types:
b1) only certain authorizations or a certain type of authorization are/is addable to the authorization profile;
b2) only certain authorizations or a certain type of authorization are/is removable from the authorization profile;
b3) there is a maximum limit for the number of addable authorizations;
b4) there is a minimum limit for the number of authorizations that must remain in the authorization profile;
b5) the addition or the removal of authorizations may take place within certain time periods and/or at certain times of day;
b6) the addition or the removal of authorizations can take place only when a certain further condition besides the enabling of the digital representation is met.

8. The method according to claim 1, further including:
providing an authorization pool that includes available authorizations, it being possible for authorizations of the authorization pool that are newly available to be created by at least one authorization issuer, who preferably is neither the owner nor the issuer of the physical object and/or is preferably an actor who is different from the service provider of the goods and/or services.

9. The method according to claim 1, wherein the configuring of the authorization profile of the digital representation may be carried out by an authorization issuer, preferably by multiple authorization issuers, the authorization issuer being neither the owner nor the issuer of the physical object, and/or being an actor who is different from the service provider of the goods and/or services.

10. The method according to claim 1, wherein the configuring of the authorization profile of the digital representations takes place at least semiautomatically, in that the authorizations that are available for the digital representation are preferably automatically preselected, based on a certain feature of the digital representation, via machine learning.

11. The method according to claim 1, wherein a retrieval of the goods and/or services by a service recipient from a service provider is possible only when at least one predefined condition is met, it being possible in particular for the condition to be how frequently the good and/or service are/is permitted to be retrieved, at what time the good and/or service are/is permitted to be retrieved, or at what location the good and/or service are/is permitted to be retrieved.

12. The method according to claim 1, further including:
storing a piece of retrieval information in the digital representation after a retrieval of the goods and/or services has taken place, the retrieval information preferably including information concerning whether and how often a good and/or service have/has been retrieved, and also preferably including a time stamp for each retrieval.

13. An IoT platform, or digital representation of a physical object, or reading device, which is preferably designed as a mobile terminal or an output device, and that is configured to carry out the particular steps of the method according to claim 1.

14. An output device of goods and/or services, wherein the output device includes a reading device and preferably is designed as a beverage vending machine, the output device being configured and designed to carry out the method according to claim 1.

15. A computer program that includes commands which, when the program is executed by a computer, prompt the computer to carry out the method according to claim 1.
